(19) United States
(12) Patent Application Publication
(10) Pub. No.: US 2016/0078122 A1
(43) Pub. Date: Mar. 17, 2016

(54) GEOSPATIALLY SELF-LOCATING AND SELF-LIMITING SEARCH ENGINE

(71) Applicant: The PluggedIn Group, LLC, PHILADELPHIA, PA (US)

(72) Inventor: AISHA WHITMAN, PHILADELPHIA, PA (US)

(21) Appl. No.: 14/852,193

(22) Filed: Sep. 11, 2015

Related U.S. Application Data
(60) Provisional application No. 62/049,679, filed on Sep. 12, 2014.

(51) Int. Cl. G06F 17/30

(52) U.S. Cl. CPC G06F 17/30598; G06F 17/30038; G06F 17/30569; G06F 17/3002; G06F 17/30064

(57) ABSTRACT

The present invention provides methods for converting data in a database into geospatial data and geoindexing the geospatial data. Methods may further include receiving a query for a geospatial location via at least one web platform and presenting a geospatial dashboard for the geospatial location. Methods may also include receiving a query for information via the geospatial dashboard, searching the database for data relevant to the query, finding the relevant data, and presenting only the relevant data associated with the geospatial location.

The present invention also provides methods for sending a query for a geospatial location via at least one web platform and receiving a geospatial dashboard for the geospatial location. Methods may further include sending a query for information using the geospatial dashboard and receiving only the queried information associated with the geospatial location.

The present invention also provides for products produced by the methods of the present invention and for apparatuses used to perform the methods of the present invention.

### CROSS-REFERENCE TO RELATED APPLICATIONS

This application claims priority to U.S. Provisional Application Ser. No. 62/049,679, filed Sep. 12, 2014, the contents of which is hereby incorporated by reference in its entirety for all purposes.

### FIELD OF THE INVENTION

The disclosed invention is in the field of search engine technology.

### BACKGROUND OF THE INVENTION

When using search engines, users may be confronted with inaccuracy of data results. Often, queries searched are not adept in providing results that are specific to a user's actual location. Users using popular websites may have several issues.

Results yielded from searches may be too far away from where the user is. For example, a search for banks in area code 19146 yields a first result listing in area code 19104 even though the user was specific in stating his area code.

Results may also be presented in a distorted order and be biased by reviews.

Results may be missing important information. For example, users should have the ability to know that a trip to a restaurant approximately 25 miles away may be affected by a rain storm without having to remember to check another site for the weather for that area.

Additionally, websites may have categorical headings that feature categories that do not exist for the user's area. For example, a user may click on a category like “Food Truck”, and the system may respond with a page stating the lack of data present for that query.

Thus, there is a need for methods and systems to present geospatially-relevant and geospatially-limited search results in response to a user query. The invention is directed to these and other important needs.

### SUMMARY OF THE INVENTION

The present invention provides methods for converting data in a database into geospatial data and geoindexing the geospatial data. Methods may further include receiving a query for a geospatial location via at least one web platform and presenting a geospatial dashboard for the geospatial location. Methods may also include receiving a query for information via the geospatial dashboard, searching the database for data relevant to the query, finding the relevant data, and presenting only the relevant data associated with the geospatial location.

The present invention also provides systems that perform those methods. The systems may comprise a server, and the server may comprise at least one computer communicatively connected to a computer network and communicatively connected to a database. The server may have stored thereon computer instructions that during execution cause the system to perform operations comprising: converting data in the database into geospatial data; and geoindexing the geospatial data. The server may also have stored thereon computer instructions that during execution cause the system to perform operations further comprising: receiving a query for a geospatial location via at least one web platform; and presenting a geospatial dashboard for the geospatial location. The server may further have stored thereon computer instructions that during execution cause the system to perform operations further comprising: receiving a query for information via the geospatial dashboard; searching the database for data relevant to the query; finding the relevant data; and presenting only the relevant data associated with the geospatial location.

The present invention also provides methods for sending a query for a geospatial location via at least one web platform and receiving a geospatial dashboard for the geospatial location. Methods may further include sending a query for information using the geospatial dashboard and receiving only the queried information associated with the geospatial location.

The present invention also provides systems that perform those methods. The systems may comprise a server, and the server may comprise at least one computer communicatively connected to a computer network and communicatively connected to a database. The server may have stored thereon computer instructions that during execution cause the system to perform operations comprising: sending a query for a geospatial location via at least one web platform and receiving a geospatial dashboard for the geospatial location. The server may further have stored thereon computer instructions that during execution cause the system to perform operations further comprising: sending a query for information using the geospatial dashboard and receiving only the queried information associated with the geospatial location.

The general description and the following detailed description are exemplary and explanatory only and are not restrictive of the invention, as defined in the appended claims.

Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates an embodiment of the present invention directed to baseline search fields and a tiered aggregation method;

FIG. 2 illustrates an embodiment of the present invention directed to a geospatial search engine process;

FIG. 3 illustrates an embodiment of the present invention directed to menu options, geospatial dashboard items, and content classification registry categories; and

FIG. 4 illustrates an embodiment of the present invention directed to a graphical user interface.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. Any reference to a masculine term, e.g., “he” or “his,” also includes the feminine term, e.g., “she” or “hers,” and vice versa unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, references to values stated in ranges include each and every value within that range.

When using search engines, users may be confronted with inaccuracy of data results. Often, queries searched are not adept in providing results that are specific to a user's actual location. Further, results may be presented in a distorted order or having a biased listing based on reviews, categorical headings may be present without local data, and current results do not allow users to plan their excursions comprehensively enough. Disclosed embodiments provide, but are not limited to, solutions to these issues.

### Terms

“Content classification registry,” as the term is used herein, refers to data organized according to a predetermined content classification within a given geospatial purview.

“Geoindex,” as the term is used herein, refers to the act of indexing data that has been tagged by geographic location.

“Geospatial,” as the term is used herein, refers to a specific geographic area.

“Geospatial dashboard,” as the term is used herein, refers to a web page or other user interface that presents all categorizations and data as well as keyword search capability of a user's geospatial query.

“Geospatial data,” as the term is used herein, refers to data that has a geospatial area(s) associated with its information.

“Geospatial data zone,” as the term is used herein, refers to the limit placed upon search engine data-retrieval by a specific geographic area, e.g., a zip code.

“Geospatial destination,” as the term is used herein, refers to a specific real world geographic zone, e.g., Queens, N.Y.

“Geospatially specific data field,” as the term is used herein, refers to data on an existing real word element, specific to a geographic zone.

“Highest user activity,” as the term is used herein, refers to the highest number of user activity/clicks performed on a geospatial specific data field, e.g., the number of times a bagel store has been clicked on by users on the site.

“Human driven,” as the term is used herein, refers to an activity done by humans.

“Internet-interactive device,” as the term is used herein, refers to any piece of machinery that allows a user to gain access to and interact with the internet.

“Lowest user activity,” as the term is used herein, refers to the lowest number of user activity/clicks performed on a geospatial specific data field, e.g., the number of times a bagel store has been clicked on by users on the site.

“Non-geospatial information,” as the term is used herein, refers to data relevant across geospatial boundaries.

“Pet name' zones,” as the term is used herein, refers to colloquial terms used to describe specific geographical zones, which may be smaller than or larger than the smallest geospatial categorization field of an embodiment such as a zip code if in the United States.

“Predetermined categories,” as the term is used herein, refers to categories of real world elements that can be found across geographic zones, e.g., Fast Food Restaurants.

“Sub zip code(s),” as the term is used herein, refers to the smaller elements of a broken-down zip code.

“Web platform,” as the term is used herein, refers to the World Wide Web, online-dependent applications, programs, platforms, websites, or any other interrelated systems allowing users to access search data, including internet-interactive devices.

The solution disclosed herein includes systems comprising a server, the server comprising at least one computer communicatively connected to a computer network and communicatively connected to a database, the server having stored thereon computer instructions that during execution cause the system to perform operations comprising: converting data in the database into geospatial data; and geoindexing the geospatial data. The geoindexed data may be logically divided into subsets based on geospatial location, and each subset may have at least one categorical tag attribute. The server may also have stored thereon computer instructions that during execution cause the system to perform operations further comprising: receiving a query for a geospatial location via at least one web platform; and presenting a geospatial dashboard for the geospatial location. The server may further have stored thereon computer instructions that during execution cause the system to perform operations further comprising: receiving a query for information via the geospatial dashboard; searching the database for data relevant to the query; finding the relevant data; and presenting only the relevant data associated with the geospatial location.

The solution disclosed herein also provides methods comprising sending a query for a geospatial location via at least one web platform; and receiving a geospatial dashboard for the geospatial location. The query may include at least one of a city, neighborhood, zip code, street, cross street, borough, town, suburb, district, “pet name” or polar local nickname for a location, and cartographical location. The query may also be performed via GPS location. Methods may further comprise: sending a query for information using the geospatial dashboard; and receiving only the queried information associated with the geospatial location. The received information may be sorted alphabetically or by previous interaction with the information.

Embodiments provide data search results over the World Wide Web, online-dependent applications, programs, platforms, websites, or any other interrelated systems allowing users to access search data, including internet-interactive devices (collectively “web platforms”). Web platforms may automatically geoindex data and upload it to an associated server, or other storage medium such as a database, and convert the data into geospatial data. Web platforms may also allow for manually geoindexing of data uploaded to an associated server, or other storage medium, and convert the data into geospatial data. Web platforms may be able to recognize all geoindexed data in geospatial specific categories or logical subsets with categorical tag attributes, including but not limited to city, neighborhood, zip code, street, cross street, borough, town, suburb, district, colloquial or “pet names” or polar local nicknames for locations, and the cartographical locations of any of the above.

Users may search in one or more geospatial categories. Based on a user's location selection, the system may produce a user interface that has pre-indexed and categorized data for that user-specified location. The user may search through the system's associated server or other storage medium, which might include a database, for a specific geospatial location and make a query in that location by entering a keyword into a search field, initiating a search through the system's stored data. Users may also have the option to have the system determine a user's present location before the user queries the system for specific data. In such cases, the system may query the user for his search radius or distance from his GPS location, which may include searching up and down a street or creating a search zone radius around the user's location that can be adjusted manually by the user.

Geoindexed data may be sorted into categorical headings, which may or may not be simply lists of places, for presentation to the user. The geoindexed data may be presented on a geospatial dashboard that includes at least one geospatial specific category heading for the geospatial location. Such headings may include, but is not limited to, schools, parks, cultural attractions, municipal service offices, emergency service centers, hospitals, restaurants, bars, and religious buildings.

Geoindexed data may have more than one categorical tag. For example, a geospatial data field like a restaurant in zip code 19118 will also be recognized by the system as belonging to Chestnut Hill, North-East Philadelphia, and Philadelphia will appear on the Chestnut Hill, North-East Philadelphia, and Philadelphia query result page for “restaurant” or be part of a restaurant category in those zones.

Some embodiments store data about geographic zones on a server or other storage medium associated with a website and constantly update that data. Geographic zone data is stored with the smallest geographical tag available, e.g., latitude and longitude, zip codes, sub zip codes, etc. The smallest geographical tag is useful for providing localized results when a user requests a search on a specific street or radius around his GPS location. For example, results may be geoindexed so that a user may request restaurants on Avenue of the Arts, and embodiments will provide him only with restaurants on that Avenue. Query results may be micro-specific, including but not limited to search radius, lateral search, or zone search.

Some embodiments display results via click action density. Where there is no click action for a certain result, the results are displayed in alphabetical order. Results are interpreted as data, devoid of emotion via reviews.

Some embodiments provide basic geographical and meteorological data as well as news for each geographic zone. Users have the ability to see such data on their user interfaces to allow them to make more informed decisions about excursions.

Some embodiments may also provide categories or a lack of categories for the geographic zone a user explores. For example, a “Food Truck” category may display available food trucks to one user, while another user will not be offered a “Food Truck” category because there is no relevant data for that category in the user's area.

In some embodiments, a single field query option is presented to the user with the option to enter a specific zip code or name of geographic area. Upon entering a query, a feed presents a geospatial destination with a wide variety of information and content pertinent to the geospatial query. This destination subsequently features a keyword search prompt that produces query responses to such specific keywords within the destination zone. Thus, the first geospatial query and associated geoindexed destination provides a platform which significantly increases the relevance and accuracy of its results as per the needs of its users. In addition, the geospatial destination platform provides exposure and access to the unique features, such as businesses, news, parks and recreation spots, etc., of the physical geographical area that it represents.

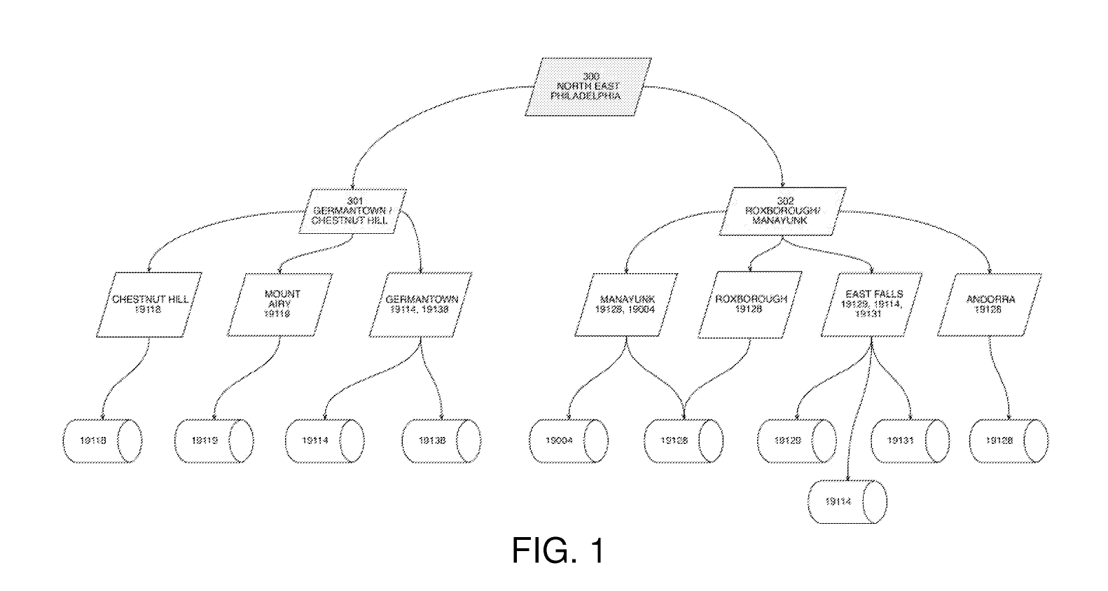

An example of geospatial unitization and aggregation is shown in FIG. 1. North East Philadelphia (300) is a sample region which can be broken into two major neighborhoods, Germantown/Chestnut Hill (301) and Roxborough/Manayunk (302), which are comprised of smaller recognizably-named neighborhoods (e.g., Chestnut Hill, Mount Airy, Germantown, Manayunk, Roxborough, East Falls, and Andorra). These neighborhoods are comprised of zip code(s)/sub zip code(s) which may overlap. On servers hosting embodiments of this disclosure, the scripted code will contain a national mapping database consistent with the example of FIG. 1. In this way, it responds to searches done by zip codes, neighborhoods, and subsequently-tried queries, all of which will be based upon the coded zip code(s)'/sub zip code(s)' identification and subsequent aggregations which may be known by name rather than number. Queries that contain sub zip code sized areas, streets, or colloquial “pet names” for areas, any of which might be smaller or greater than the zip code boundaries, are also recognized by disclosed embodiments, and the geospatial specific data for respective “pet-named” zones will be retrieved.

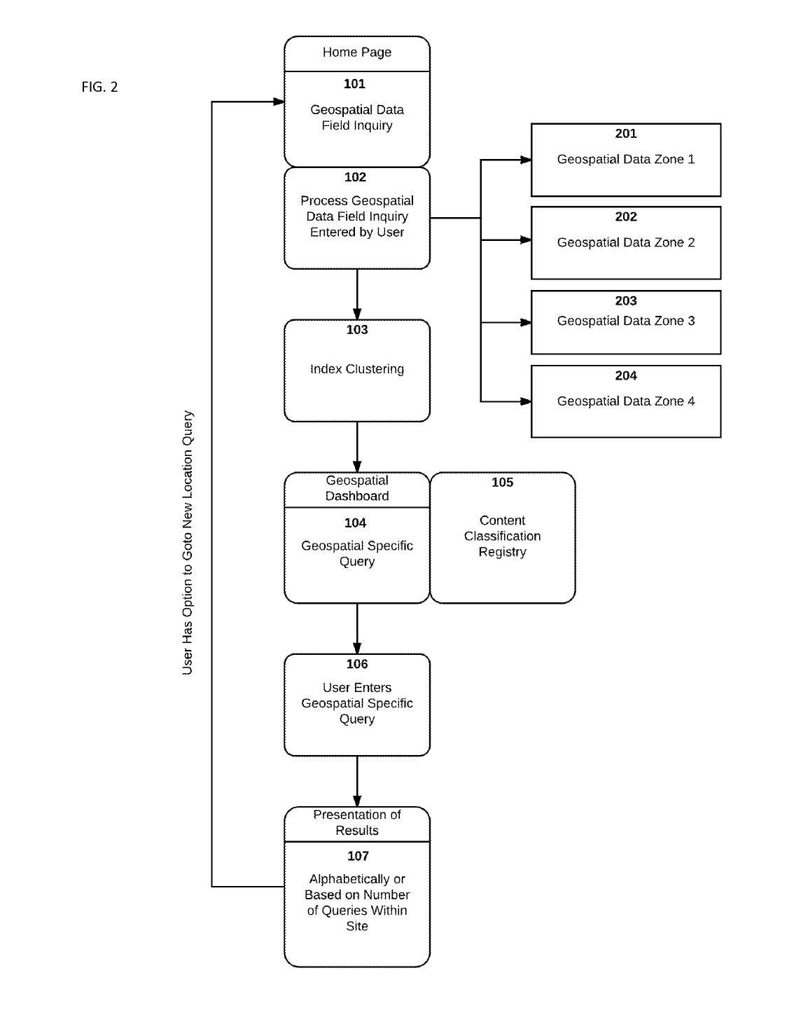

FIG. 2 shows an example geospatial search engine process, including data indexing and storage. Data may be stored into zip code and/or sub zip code delineated fields. Because embodiments allow a geospatial query either by zip code number or name of geographic area, the name of the geographic area may be associated with the zip codes or sub zip codes contained in storage. An initial user query (101) causes the engine to retrieve and present a “geospatial dashboard” (104), or “area dashboard”, wherein a vast array of information is organized by predetermined categories (105) and displayed as aggregated geospatially limited data relevant to the zip code or aggregated zip codes within which it is defined. On this “dashboard” is a search field/search bar in which the user may enter an addition query or keyword (106) to specify what the user is requesting. The result of this request is limited to the user's previously defined geospatial area of interest, as are many pieces of data accessed on a given geospatial dashboard.

The system may store all queries made by any user anywhere, including searches without existing data fields or results (e.g., searching “Center, Texas”, followed by using the keyword “hospital” on the Center Texas dashboard will yield no results, as a hospital no longer exists there). Sometimes a lack of query results are beneficial for users and business owners, who can use analytics on such as a guide as to what is available and what market opportunities and targets exist in the area. The system may store all keywords and queries searched by any user and store them with the following information, for example: Number of times entered by users; User ID, if user is a member; Time stamp; Geospatial stamp, e.g., where the users are searching or their geospatial search field for the keyword/query; and Number of results generated from the keyword search.

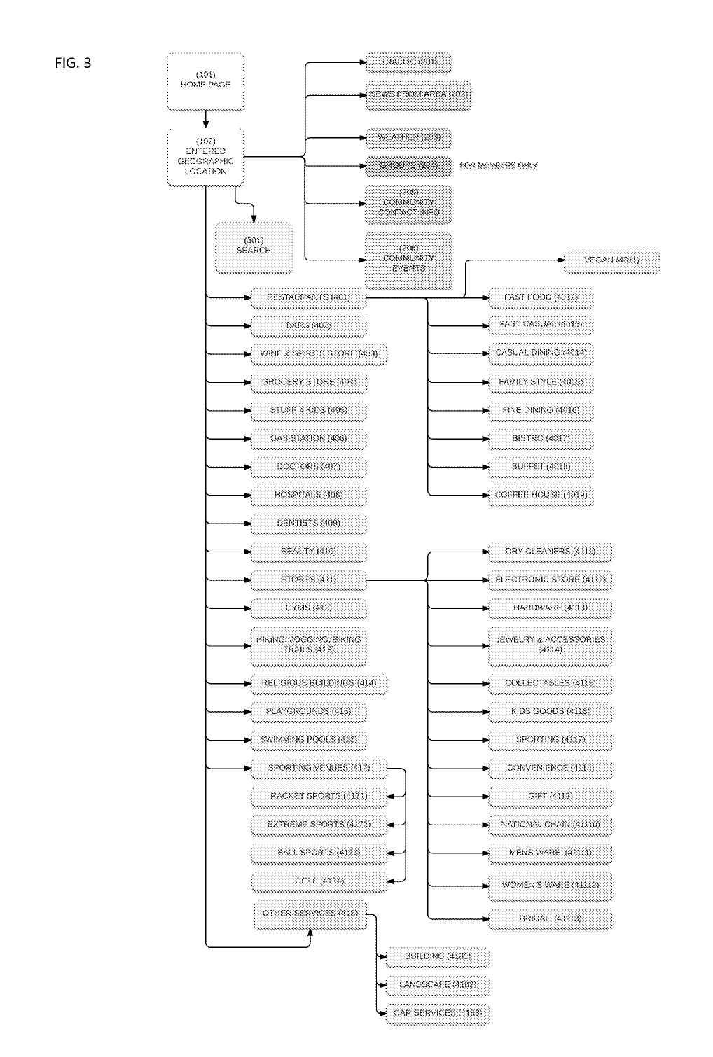

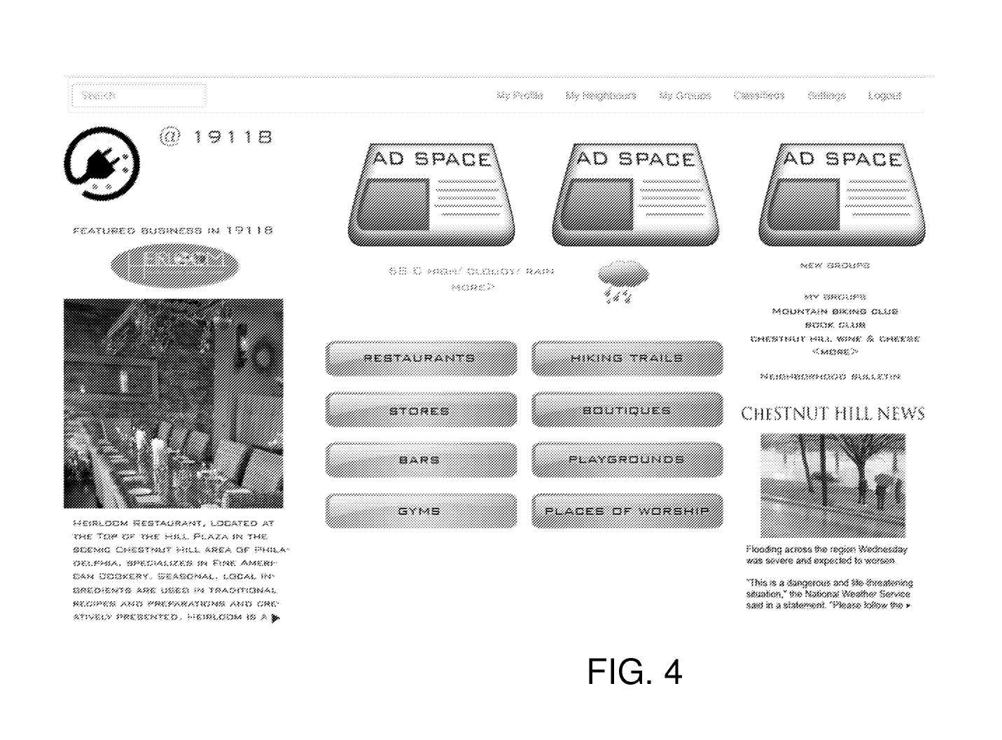

Embodiments mimic approximately the ability to virtually be in a geographic zone by first asking the user where he wants to go or where he wants to be. The homepage, shown as (101) in FIG. 2, is a query on location. Typing in a location such as “The Castro” results in the search engine identifying that The Castro is in San Francisco, California, and displaying relevant, geospatial-specific data present on the site about the famous location, shown as “Index Clustering” (103) in FIG. 2. Zip coded and sub zip coded data is automatically aggregated to create the geographical boundaries of The Castro. The geospatial “Castro dashboard”, shown as (104) in the flow process of FIG. 2, may display general data on The Castro, such as local newspaper headlines, important municipal and crisis numbers, the weather forecast for the area, traffic alerts, a map of The Castro in relation to the nearest metropolis by which it is contained, a link to a fact site of The Castro, etc. The geospatial dashboard may also display, in predetermined categories, what is available in The Castro, such as food carts, biking/running routes, shops, doctors, dentists, hospitals, etc., as well as prompt the user for specific keyword queries for the area. Example general data is shown in FIG. 3, and an example geospatial dashboard for zip code 19118 is shown in FIG. 4. Geospatial specific queries may be made by the user by either clicking on the geospatial dashboard's content classification heading or by entering a keyword search on the same page, steps (104) and (106) in FIG. 2.

Results of user queries are listed from highest user activity to lowest user activity followed by an alphabetical list of geospatial specific fields of data with no activity. For example, a user entering the keyword query “pizza” in “The Castro dashboard” keyword search field displays results that have been selected or clicked more often by users displayed first, followed in descending order by keyword-relevant geospatial specific data fields clicked less frequently. After the initial list, further query results are organized in alphabetical order. In a zone that has not experienced any selection history by the user, all geospatial specific data is listed in alphabetical order, as shown in step (107) of FIG. 2. This also is the method of displaying geospatial specific data in predetermined categories of the aggregated results of geospatial dashboards.

On a geospatial dashboard, like the example one shown in FIG. 4, the website allows users to view general geographic information about the area as well as other data, including but limited to: Weather forecasts; Traffic; Emergency numbers and locations; Headline news for the location; Categorization headlines of, for example, facilities, user amenities, places of interest, and other geographically specific businesses; Geographical data for the location, including but not limited to relationship of location to neighboring central business district, other colloquial names for the area, square miles of the area, height above sea level, and neighboring water bodies; and a search bar, where users can narrow down a search, which may be based on a predetermined location specification that produced the interface. The user interface may also operate as a geographic tool.

Users may customize the type of geographical information presented to them on the geospatial dashboard. They have the option of displaying all of the additional data presented on the geospatial dashboard and may reduce or add to available data.

Users may also customize the number of categorization headlines. For example, if current categories are facilities, user amenities, places of interest, and other geographically specific businesses, and a user is only interested in places of culture, restaurants, or hotels, the user has the option to display only those fields for the geographic zone of choice. Users may reorganize the category list headings, eliminate category list headings, and select sources for a local news feed.

Disclosed embodiments have a large number of applications.

Some embodiments may provision general data for geographic locations for research purposes. In these embodiments, users can query statistical results. For example, after typing a city, a user may query, “how many private schools”. The results will not only provide a spot map showing the private school locations, but also provide the number of private schools and their addresses.

Some embodiments may provide data on user query density for numerous data fields. These embodiments store all queries input by users and include geographic density and result numbers. Such data is useful for many different types of research, including market research. For example, an embodiment informs a user that within the last month there have been 1,034 queries for bars in Stillwater, Oklahoma, and there are only 4 results for bars there. Such data may encourage new business owners to consider opening a bar in Stillwater, Oklahoma. In another example, an embodiment informs a user that there have been 3,040 queries in the last six months for hospitals in Shelby County, Center, Texas. Of the 3,040 queries, 643 were queries input locally, 67 were input from the state of Texas, and the rest were spread across the nation. The result of the query is zero (0) because the last hospital existing there closed down in November, 2013. This information can be used by a number of different kinds of professionals/researchers.

Some embodiments may provide data on general user behavior. For example, an embodiment informs a user that there have been 234 queries on bridal-related services in the suburbs of Philadelphia versus 36 in center city Philadelphia.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A system comprising:
a server, the server comprising at least one computer communicatively connected to a computer network and communicatively connected to a database, the server having stored thereon computer instructions that during execution cause the system to perform operations comprising:
converting data in the database into geospatial data; and
geoindexing the geospatial data.

2. The system of claim 1 wherein the geoindexing the geospatial data is performed manually.

3. The system of claim 1 wherein the geoindexed data is logically divided into subsets based on geospatial location, and each subset has at least one categorical tag attribute.

4. The system of claim 3 wherein the categorical tag attributes include city, neighborhood, zip code, street, cross street, borough, town, suburb, district, “pet names” or polar local nicknames for locations, and cartographical locations.

5. The system of claim 1, the server having stored thereon computer instructions that during execution cause the system to perform operations further comprising:
receiving a query for a geospatial location via at least one web platform; and
presenting a geospatial dashboard for the geospatial location.

6. The system of claim 5 wherein the geospatial dashboard includes at least one geospatial specific category heading for the geospatial location.

7. The system of claim 6 wherein the at least one geospatial specific category heading includes schools, parks, cultural attractions, municipal service offices, emergency service centers, hospitals, restaurants, bars, and religious buildings.

8. The system of claim 5, the server having stored thereon computer instructions that during execution cause the system to perform operations further comprising:
receiving a query for information via the geospatial dashboard;
searching the database for data relevant to the query;
finding the relevant data; and
presenting only the relevant data associated with the geospatial location.

9. The system of claim 8 wherein the database stores the query and compiles at least one type of statistic about the query.

10. The system of claim 9 wherein the at least one type of statistic includes number of times query is received, associated user ID, time stamp, geospatial stamp, and amount of the relevant data presented.

11. The system of claim 9 wherein the at least one type of statistic is used for the presenting of the relevant data.

12. The system of claim 5 wherein the query for a geospatial location is received via GPS location.

13. The system of claim 5 wherein the geospatial dashboard is customizable.

14. A method comprising:
sending a query for a geospatial location via at least one web platform; and
receiving a geospatial dashboard for the geospatial location.

15. The method of claim 14 wherein the query includes at least one of a city, neighborhood, zip code, street, cross street, borough, town, suburb, district, “pet name” or polar local nickname for a location, and cartographical location.

16. The method of claim 14 further comprising:
sending a query for information using the geospatial dashboard; and
receiving only the queried information associated with the geospatial location.

17. The method of claim 16 wherein the received information is sorted alphabetically.

18. The method of claim 16 wherein the received information is sorted by previous interaction with the information.

19. The method of claim 14 wherein the sending a query for a geospatial location is performed via GPS location.
